(19) United States
(12) Patent Application Publication
(10) Pub. No.: US 2023/0042184 A1
(43) Pub. Date: Feb. 9, 2023

(54) IMPROVEMENTS IN OR RELATING TO PACKAGING OR CONTAINERS FOR A FOODSTUFF

(71) Applicant: STREET FOOD BOX LIMITED, Cambridge (GB)

(72) Inventor: Edward James STABLEFORD, Cambridge (GB)

(21) Appl. No.: 17/791,952

(22) PCT Filed: Jan. 8, 2021
(86) PCT No.: PCT/GB2021/050045

§ 371 Date: Jul. 11, 2022

(30) Foreign Application Priority Data
Jan. 12, 2020 (GB) 2000429.7
May 4, 2020 (GB) 2006535.5

(51) Int. Cl. B65D 1/22; B65D 1/24; B65D 81/24; B65D 81/34; B65D 77/24

(52) U.S. Cl. CPC B65D 1/225; B65D 1/24; B65D 81/24; B65D 81/3453; B65D 77/245

(57) ABSTRACT

Disclosed is a container for a foodstuff preferably comprising a lid (12) and a secondary compartment, the container being convertible between an at least partially collapsed configuration and an erected configuration; the container being washable and re-usable and wholly or substantially formed of a synthetic plastics material which is foldable and impermeable.

### FIELD OF THE INVENTION

The present invention relates to a novel item of packaging for a foodstuff, to a flat blank for making the item of packaging, and to a method of making the item of packaging.

### BACKGROUND OF THE INVENTION

There is increasing awareness of the scale of the environmental damage caused by single-use plastic packaging. This, along with other factors, is driving the move towards the use of other, less environmentally damaging, materials and to increased recycling. However, presently every year British households throw 22 million tonnes of waste in the bin. Recycling rates have stagnated at around 44% in the UK.

Hundreds of thousands of tonnes of recycling sorted by households are being sent to landfill or incinerators because it has not been properly sorted and this has increased by 84% over the past 4 years, according to official figures. In some areas as much as 15% of the rubbish separated for recycling is rejected. Council officials suggest the reason for this is that some bins are “contaminated” with items which cannot be recycled, after waste has been incorrectly sorted by householders.

In addition, it has become common for workers to buy a take-away lunch, with items such as sandwiches, crisps or other snacks, and bottles of water or drinks being especially popular. These are typically provided with a paper napkin or the like. A recent survey conducted by an environmental charity estimated that this “lunch on the go” activity generated over 10 billion separate items of waste over the course of one year. Again, much of this waste cannot be recycled in an economically viable way because it is made from mixed materials and/or contaminated with food residue.

There is thus a clear need for improved food packaging which produces less non-recyclable waste.

### SUMMARY OF THE INVENTION

In a first aspect the invention provides a container for a foodstuff, the container being convertible between an at least partially collapsed configuration and an erected configuration, the container being washable and re-usable and wholly or substantially formed of a synthetic plastics material which is foldable and impermeable.

The container may be any shape but typically comprises a main body, defining a main compartment volume for receiving a foodstuff, and a lid for covering the foodstuff within the container. Conveniently the main body comprises a square or rectangular base surrounded by, and joined to, upright side and end walls. In preferred embodiments, the lid is formed of the same synthetic plastics material as the main body of the container, and is foldably or hingeably connected to one of the side or end walls, such that the lid can be opened to allow a foodstuff to be positioned in the main body of the container, and then closed to keep the food within the container. In some embodiments the lid is an integral part of a flat blank used to form the container, whilst in other embodiments the lid may be formed initially as a separate component and subsequently joined to the container, typically by means of ultrasonic welding.

Preferably the lid and/or the main body is provided with releasable fastening means to fasten the lid in the closed position when desired, whilst allowing the lid to be opened to permit consumption of the foodstuff, washing of the interior of the container etc. Numerous methods of achieving such releasable fastening can be envisaged including, but not limited to, a releasable press stud arrangement, or a tab/flap or tab/slit arrangement, in either of which there is co-operation between respective features on the lid and the main body of the container to effect the fastening. A press stud arrangement is not preferred, as this is likely to require the incorporation of other materials into the container, and a desirable feature of the invention is that the container is wholly or substantially formed from a single material to facilitate, inter alia, recycling thereof. Accordingly, a tab/flap or tab/slit arrangement is advantageous, since these features can be formed from the same material as the rest of the container (and indeed form an integral part of the container), and one particular such arrangement is described in further detail elsewhere below.

In a preferred embodiment, the lid and the main body are substantially formed from a single material, such that the container is both easy to manufacture and also readily re-cycled. More especially, the container is advantageously constructed wholly or substantially from a single sheet of flexible substrate, preferably a synthetic plastics material, which can be folded and assembled to form the container. The container of the invention thus, in preferred embodiments, lends itself to manufacture at least in part as a flat blank which can be cut out or stamped out from a flexible substrate material, and then folded and assembled into the container of the invention. The inventor has found that an especially suitable material for the container is polypropylene, which is safe and approved for use with foods for human consumption.

An example of suitable polypropylene is that available under the trade mark Priplak®, (from Priplak SAS, Parc d'activités industrielles, Avenue de l'Europe, 60 530 Neuilly-en-Thelle, France; although it should be noted that suitable polypropylene materials are widely available from other manufacturers), in particular the grade of Priplak® sold under the trade mark IZLYSS. This material has a density of 0.91 gm/cm³ and is available with a thickness in the range 280-1600 μm. An especially suitable thickness is about 400-650 μm, which is thin enough to be flexible and easily folded and partially collapsed, but sufficiently thick to allow the resulting container to be robust, leak-proof and durable. It can be glued (especially using hot melt polyurethane reactive or cyanoacrylate glues), or joined using ultrasonic or hot-air welding. The latter methods are preferred for use in making the container of the invention as they avoid introducing discontinuities and preserve and enhance the leak-proof nature of the assembled container.

The material may be transparent, translucent or opaque, and may be colourless or coloured. In addition, part or all of the exterior surface of the container may be textured or smooth, and one or more trade marks, logos, elements of branding, or labels (e.g. providing information about a retailer and/or about the packaged foodstuff) may be provided.

In a typical embodiment the assembled container comprises a corner tab at each of the four corners of a rectangular or square base, the corner tabs being preferably continuous with, and connected to, respective adjacent end and side walls. These corner tabs ensure that there are no gaps at the corners of the assembled container through which a leak could occur.

As noted above, the container of the first aspect of the invention is especially suitable for manufacture, at least in part, as a flat blank, which can be folded and secured to form an assembled container. Conveniently the flat blank is such that at least one fold line or crease is provided at a pair of opposite corners of the main body of the container, more preferably at least one fold line or crease is formed at each of the four corners of the main body. Such fold lines or creases are desirably provided on the aforementioned corner tabs which are located at, and continuous with, the base of the main body and with the side and end walls.

Advantageously the fold line or crease is provided as a diagonal fold line or crease which substantially or exactly bisects the corner tab. This facilitates inward folding of the corner tab during assembly of the container from the flat blank. In this way, the corner tabs ensure that, in the assembled container, there is no gap between the edges of the adjacent side and end walls, and no gaps between the side/end walls and the base, such that the corners of the assembled container are leak-proof. As such, the container of the invention is considered as substantially leak-proof in its erected configuration, although it will be apparent that the container is not entirely leak-proof as there may be small gaps between the lid and the top edges of the upright side and end walls. As a result, the contents of the container could leak if the container is over-filled or if the container is tilted or inverted such that the contents encounter any such gaps between the lid and the top edges of the upright walls.

In addition to the fold lines in the corner tabs, it is preferred for the assembled container (and the corresponding flat blank) to have at least one fold line or crease in one or more of the side and/or end walls, which walls are attached to, and continuous with, the base. More especially, it is preferred to provide at least one fold line or crease in each of a pair of opposed end walls. In one particular embodiment, two fold lines or creases are formed in each of the two opposed end walls. The purpose of these fold lines or creases is to facilitate at least partial collapse of the container so that, when not in use, the container can be at least partially collapsed to adopt a relatively flattened shape of reduced volume for greater ease of storage and transport. In particular, it is preferred that the opposed end walls can be at least partially collapsed inwardly, rather than outwardly, so that the at least partially collapsed container remains compact. Conveniently, to facilitate attainment of this objective, each of the opposed end walls comprises a pair of generally diagonal fold lines or creases which run from the bottom corner of the container inwards towards a central portion of the top edge of the end wall. The generally diagonal fold lines or creases may meet one another at the top edge of the end wall, but this is not essential. Typically, the inward folding of the opposed end walls is accompanied by, and induces, substantially simultaneous inward folding of the opposed side walls which can, for example, fold inwards about the fold lines at their respective junction with the base and thus come to overlie the base and the inwardly folded end walls. In one such embodiment, the lid may then be folded over one of the inwardly folded side walls, resulting in an extremely compact configuration for the partially collapsed container. To facilitate this, a crease or fold line may be provided in the lid, conveniently at or about a mid-line across the lid.

In preferred embodiments, one or more inward projecting tabs are provided along all or part of the upper edge of one or more of the upright side and/or end walls. The tabs typically project inwards over the main compartment, roughly perpendicular to the upright walls and roughly parallel to the base. More especially, at least one such inward projecting tab is provided on at least two walls, advantageously on each of the pair of opposed end walls. In some embodiments, either (a) the lid (in the closed position) closes over the tabs and the tabs help to reduce or prevent splash or leakage of the foodstuff; or (b) the tabs fit over the lid (when the lid is in the closed position) and thus help to secure the lid in place.

In some embodiments, two or more inward projecting tabs (typically, a pair of tabs) are provided along the upper edge of each of the pair of opposed end walls, with a break, gap or other discontinuity between the tabs, through which break, gap or other, discontinuity, the edge of the lid can be threaded. In such embodiments, one of each pair of tabs may be folded over the lid, and one of each pair of tabs may pass under the lid, such that the edge of the lid can be sandwiched between the tabs and held in place. In this way, both features (a) and (b) of the preceding paragraph can be achieved.

In an especially preferred embodiment, at least one of the aforementioned inward projecting tabs may insert into a respective cooperating slit provided in the lid at an appropriate position to receive the tab. This tab/slit arrangement may thus constitute a releasable fastening means to fasten the lid in the closed position when desired, as described previously above. To improve the ease with which the tabs may be introduced into the respective slits, the tabs will preferably be formed with a narrower portion which first encounters the slit. For example, the tabs may be formed with an arrow head shape pointing inwards towards the slit, or with generally sloping corners at the leading edge of the tab. In a typical embodiment the tabs are generally trapezoidal in shape (i.e. resembling a rectangle but with the opposite corners of the leading, inward edge [when the tabs are folded inwards] cut at an oblique angle). Not only does this create a narrower portion which can more readily be fed into a slit in the lid, but it also has the advantage of preventing the tabs from obstructing or interfering with each other, or with the walls of the container, when the end walls are folded inwards to partially collapse the container.

Typically the material used to form the container has some resilience. Accordingly, when the container is in its at least partially collapsed configuration, the walls of the container will, to some extent, tend to return to the erected configuration. This is helpful when a user wishes to convert the container from its at least partially collapsed configuration to the erected configuration, but is not of assistance when the container is desired to remain in its at least partially collapsed configuration. It may therefore be advantageous to provide the container with retaining means which resist any such resilience and help retain the container in the at least partially collapsed configuration. Many different ways of achieving this can be envisaged. In one embodiment, for example, reciprocal male and female members may be provided either side of a fold line in one or more walls of the container, about which fold line the container is folded when in the at least partially collapsed configuration. Such folding brings the reciprocal male and female members into proximity so that they can interact. For instance, the reciprocal male and female members may form a releasable snap-fit engagement (e.g. male and female members of a press stud). Alternatively, a retaining member provided on the lid may engage with a reciprocal retaining member provided on a side/end wall or on the base of the container. As with the releasable fastening means to fasten the lid, a press stud arrangement is not preferred, as this would normally require the incorporation of other materials; thus a tab/flap or tab/slit arrangement for the retaining means will generally be preferred.

A simple alternative approach is to provide the container with a sleeve or the like, which can fit around the container when it is in its partially collapsed configuration, and keep the container compact. The sleeve could be made from any suitable material and could, for example, be made of the same synthetic plastics material as the container, so as to be recyclable therewith, or could be made from a biodegradable material, such as cotton.

A preferred embodiment of the container of the invention comprises a secondary compartment. The secondary compartment may be used to store packages or sachets of flavouring, pickles, condiments etc. and/or one or more eating implements selected from the group consisting of: knife, fork, spoon, spork or chopsticks, and will conveniently be sized accordingly.

The secondary compartment is typically formed along or adjacent to one of the side walls of the main body. Conveniently the secondary compartment does not extend beyond the length of the side wall of the main body. The secondary compartment may advantageously have its own lid, which desirably is movable separately from the lid on the main body of the container. In some embodiments, the secondary compartment is an integral part of a flat blank used to form the container, whilst in other embodiments the secondary compartment is formed initially as a separate component (typically itself manufactured by folding and assembly from a flat blank of substrate material) and subsequently joined to the rest of the container, typically by means of ultrasonic welding. In either of these embodiments it is preferred that the secondary compartment and the rest of the container are formed form the same material.

An important feature of preferred embodiments of the invention is that the container, with the packaged foodstuff inside, is suitable for heating using a microwave oven. This is because, inter alia, the container does not contain any metallic components and does not comprise any glue or other constituent which would be adversely affected by exposure to microwave radiation. Indeed, in preferred embodiments, the blank is erected into the assembled container entirely without the use of glue, typically by means of ultrasonic welding and/or thermoplastic welding.

In a second aspect the invention provides a flat blank of foldable synthetic plastics material which is adapted and configured to be folded and assembled into a container in accordance with the first aspect of the invention.

In a third aspect the invention provides a method of making a container in accordance with the first aspect of the invention, from a blank in accordance with the second aspect of the invention, the method comprising the steps of: (a) cutting out or other otherwise excising from a foldable synthetic plastics substrate a suitably shaped and dimensioned blank; (b) forming fold lines, creases or score lines in the substrate material; and (c) folding the blank along the fold lines, creases or score lines and securing the blank in its assembled configuration.

It will be apparent to those skilled in the art that steps (a) and (b) may be performed in either order although, in practice, it may well be preferred to perform step (b) before step (a). Fold lines, creases or scores may conveniently be formed in the substrate by passing the substrate through an automated folding/forming machine. Such machines are commercially available and can also perform the step of cutting or stamping out the blank, with the fold lines or creases formed therein, from the substrate material.

Conveniently the step of securing the blank may be effected, at least in part, by means of ultrasonic welding or other thermoplastic welding technique.

As noted elsewhere, whilst in some embodiments the entire container may be formed by folding and assembly from a single blank of material, other embodiments are envisaged in which one or more separate components are formed initially, and then joined to the rest of the container. In particular, one or other of a lid or a secondary compartment may be formed as a separate component and then joined to the rest of the container, typically by means of ultrasonic welding. By way of explanation, it is preferred for a secondary compartment to be located other than on a front side of the container (as, in this position, it would tend to interfere with or prevent the lid from folding around the front side wall when the container is in its partially collapsed configuration), but this preference is difficult to accommodate whilst still providing a lidded container in a form which can be manufactured from a single blank. Accordingly, where the container comprises both a lid and a secondary compartment it may be desirable to provide one of these as a separate component, rather than as integral features of the blank.

In a fourth aspect the invention provides a packaged foodstuff, packaged within the container of the first aspect of the invention.

In a fifth aspect the invention provides a method of packaging a foodstuff, using a container in accordance with the first aspect of the invention. In particular, the method of the fifth aspect may comprise the steps of: providing a container in accordance with the first aspect of the invention in its erected configuration, with the lid open; introducing a foodstuff into the container; and releasably fastening the lid of the container in its closed position. The packaged foodstuff may then, depending on the situation, be directly passed to a consumer, or may be distributed to retailers via a chilled or ambient-temperature distribution network. It should be noted that some grades of polypropylene become brittle when chilled to near 0° C., so if the packaged foodstuff is to be distributed using a chilled distribution network, some care may be required in selecting an appropriate material for the container.

If desired, the container of the invention can be manufactured so as to incorporate an antimicrobial substance. A convenient way of achieving this is to include a suitable antimicrobial additive in the monomer mix before polymerisation, in a manner similar to the inclusion of dyes. Thorough mixing prior to polymerisation is essential to ensure that the antimicrobial additive is homogeneously distributed within the plastics material. Suitable antimicrobial substances include those sold in the Microban® range. In particular, the Microban® additive IB14-5554-100 is compatible with polypropylene materials. It can be incorporated into the monomer mix at a concentration of about 2.5-5.0% to achieve an effective antimicrobial property in the polymerised plastics material

The container of the invention may find use in many different situations. For example, it may be used by food retailers to provide their food to consumers. This is especially useful in contexts where the foodstuff is to be consumed away from the premises of the retailer, such as at food markets, festivals, street food vendors, take away restaurants on high streets, in food courts at shopping malls and motorway services and so on. The retailer may add a premium to the price of food to cover the cost of providing the re-usable container. Alternatively, the container may be sold directly to customers without food, for the customer to take with them whenever visiting a takeaway food outlet. If a customer brings his or her own container to a takeaway food outlet, the retailer may offer a discount on the price of the food to reflect the fact that they (i.e. the retailer) do not have to provide their own packaging. The container is washable and made of durable material and thus may be reused multiple times, thereby substantially reducing the volume of waste food packaging.

For present purposes, the “foodstuff” which is packaged in the container of the invention may comprise prepared meals or anything which is intended for human consumption. Examples of foodstuffs which may be so packaged include noodle, rice or pasta-based meals, salads (with or without dressing) soups, cereals with milk or yoghurt. In particular the container of the invention is useful for packaging meals or snacks comprising liquid or semi-liquid constituents, in view of its substantially leak-proof nature.

The various aspects of the invention will now be described by way of illustrative example and with reference to the accompanying drawings, in which:

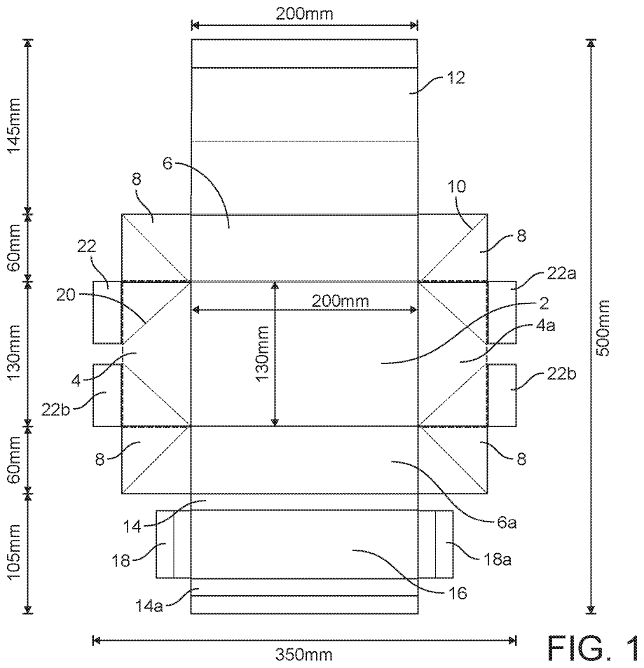

FIG. 1 is a drawing of one embodiment of a flat blank suitable for assembly into a container in accordance with the invention;

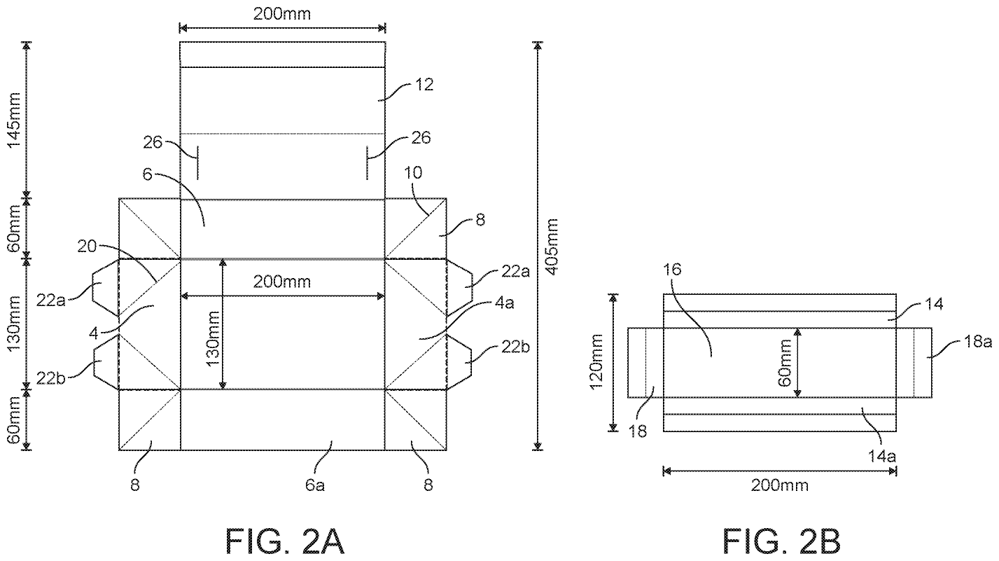

FIG. 2A is a drawing of a second embodiment of a flat blank suitable for assembly into a container in accordance with the invention;

FIG. 2B is a drawing of an embodiment of a flat blank component which may be assembled into a secondary compartment and joined to a container formed from the blank illustrated in FIG. 2A;

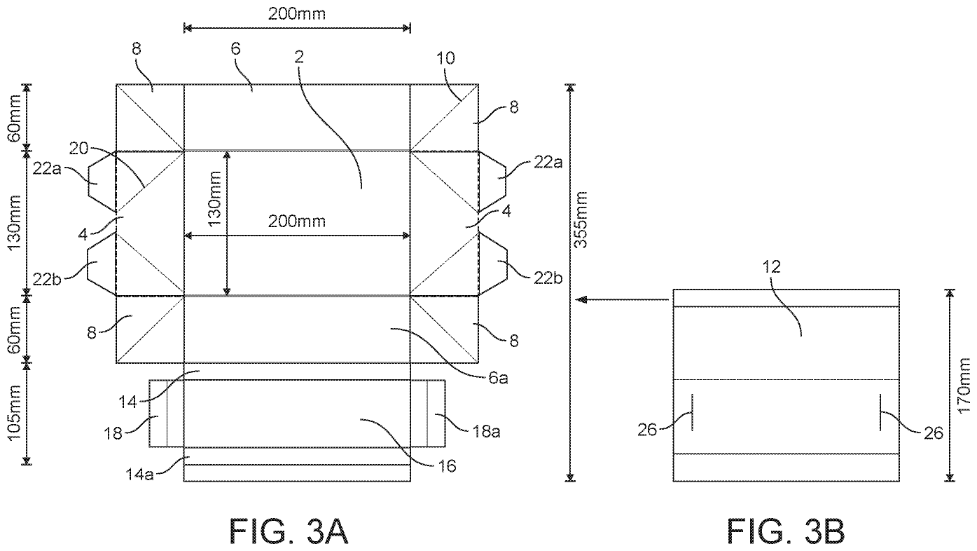

FIG. 3A is a drawing of a third embodiment of a flat blank suitable for assembly into a container in accordance with the invention;

FIG. 3B is a drawing of an embodiment of a flat blank component which may be used to make a lid and joined to a container formed from the blank illustrated in FIG. 3A;

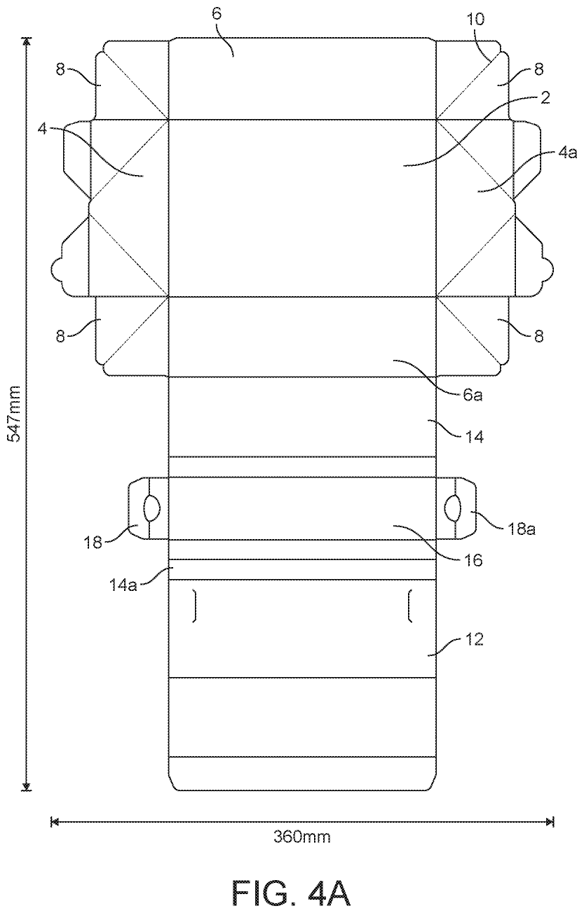

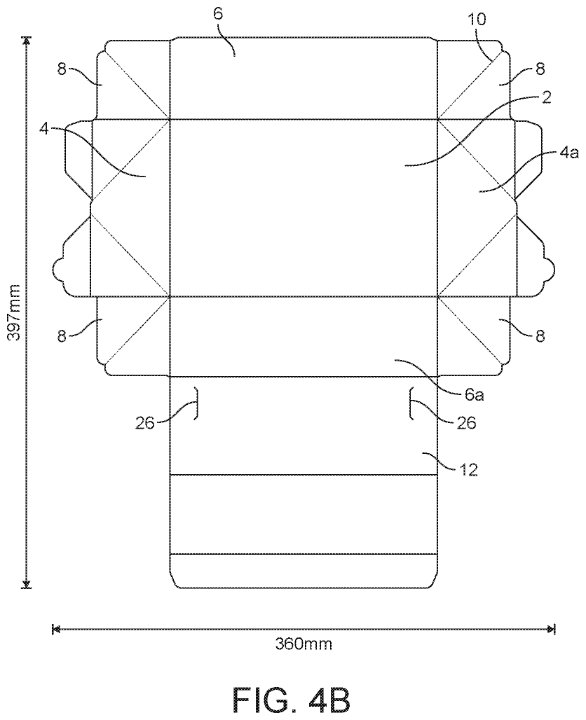

FIGS. 4A & 4B are drawings of a fourth embodiment of a flat blank suitable for assembly into a container in accordance with the invention; and

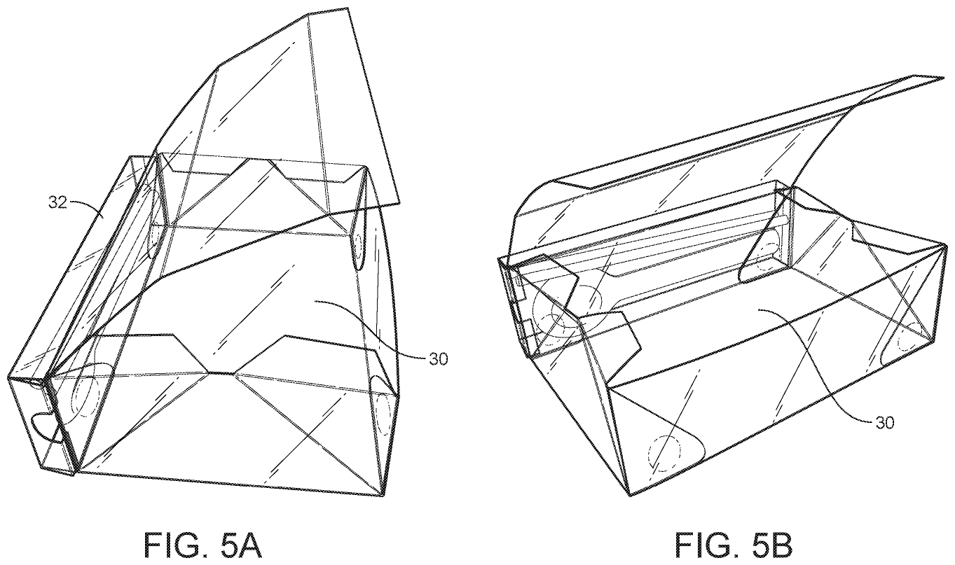

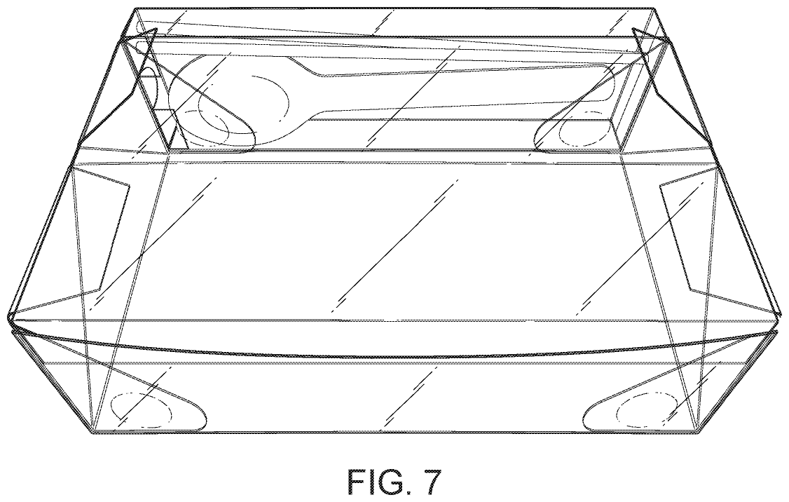

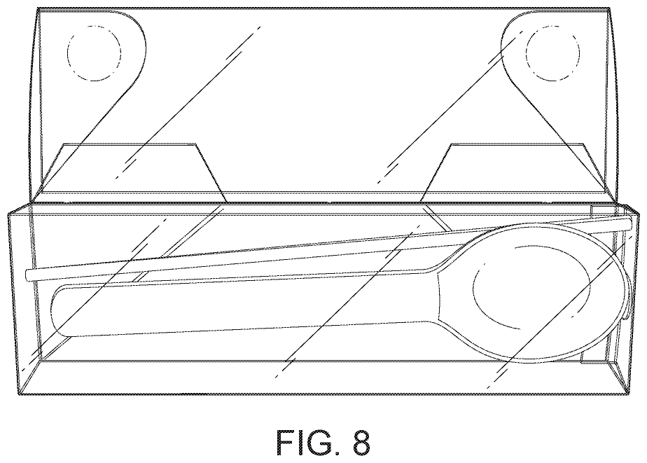

FIGS. 5-8 are various views of a container in assembled, erected configuration (with lid open or closed), the container being formed from a blank similar to that shown in FIG. 1.

### DETAILED DESCRIPTION OF EMBODIMENTS

Referring to FIG. 1, one embodiment of a flat blank suitable for assembly into a container in accordance with the invention comprises a sheet of Priplak® polypropylene, which is colourless, translucent, foldable, impermeable, washable and durable.

The blank comprises a rectangular base 2, a pair of end walls 4, 4a foldably attached to the base 2, and a pair of side walls 6, 6a foldably attached to the sides of the base 2. A corner tab 8 is provided at each corner of the base 2, the corner tabs being continuous with the respective adjacent end walls 4, 4a and respective adjacent side walls 6, 6a. Each corner tab 8 is bisected by a diagonal fold line, a representative one of which is denoted by reference numeral 10 in the figure.

The base 2 measures 200 mm×130 mm. The end walls 4, 4a measure 130 mm×60 mm. The side walls 6, 6a are 200 mm×60 mm. The square corner tabs 8 have sides 60 mm long.

A lid 12 is foldably attached to the edge of side wall 6. The dimensions of the lid are 200 mm by 130 mm. Foldably attached and adjacent to the other side wall 6a is one side 14 of a secondary compartment, which secondary compartment also comprises main wall 16 which is 200 mm×60 mm (i.e. the same size as the side walls 6, 6a of the main compartment), secondary compartment side wall 14a, and secondary compartment opposed end walls 18, 18a, either of which can act as a folding, sideways-opening lid for the secondary compartment, which lid is movable separately from the lid on the main body of the container. It will be apparent that the secondary compartment comprises three main walls (14, 14a and 16), with a fourth wall being provided by the side wall 6a of the main compartment, which wall is thus common to, or shared by, both the main compartment and the secondary compartment. The secondary compartment may be used to store packages or sachets of flavouring, pickles, condiments etc. and/or one or more eating implements such as a knife, fork, spoon, spork or chopsticks, and the secondary compartment is sized accordingly.

The secondary compartment does not extend beyond the length of the side walls 6, 6a of the main body, such that the assembled container is compact in design.

Each of the pair of end walls 4, 4a of the main compartment are provided with two substantially diagonal fold lines, of which a representative example is indicated by reference numeral 20 in the Figure. The fold lines run from the bottom corner of the container inwards towards a central portion of the top edge of the end walls 4, 4a. The generally diagonal fold lines approach each other, but do not meet, at the top edge of the end walls. The purpose of these fold lines or creases is to facilitate at least partial inward collapse of the container so that, when not in use, the container can be at least partially inwardly collapsed to adopt a relatively flattened shape of reduced volume for greater ease of storage and transport. The inward folding of the opposed end walls 4,4a is accompanied by, and induces, substantially simultaneous inward folding of the opposed side walls 6,6a which can fold inwards about the fold lines at their respective junction with the base 2 and thus come to overlie the base and the inwardly folded end walls. In the illustrated embodiment, the lid may then be folded over the front one of the inwardly folded side walls, resulting in an extremely compact configuration for the partially collapsed container. To facilitate this, a crease or fold line 24 is provided in the lid, at the mid-line across the lid.

Each of the pair of end walls 4,4a of the main compartment is also formed with a respective pair of rectangular tabs 22a,b. Each of these tabs 22a,b measure about 20 mm by 60 mm. The tabs 22a,b are foldably formed on the free edge of the side walls 4,4a, which free edge is the upper edge of the side walls in the assembled container. The tabs are folded inwardly, with a narrow gap between each pair of tabs 22a,b through which the edge of the lid can be threaded, passing over one of the pair of tabs and beneath the other pair of tabs, thus releasably fastening the lid in the closed position. Typically tabs 22a are folded over the lid, whilst tabs 22b are folded beneath the lid.

FIG. 2A shows a second embodiment of a flat blank suitable for assembly into a container in accordance with the invention, and comprises a sheet of polypropylene. The blank is substantially similar to the embodiment illustrated in FIG. 1, and like components are denoted by common reference numerals. The most significant difference between the two embodiments is that the blank shown in FIG. 2A does not incorporate, as an integral feature, a secondary compartment. Instead, this is provided as a separate component, as the blank shown in FIG. 2B. The secondary compartment is formed by folding, cutting and assembling from the blank of FIG. 2B, and then joined (by ultrasonic welding) to the container formed from the blank of FIG. 2A. Preferably the secondary compartment is joined to the rear side wall 6 of the assembled container.

The other differences in the blank of FIG. 2A, relative to that of FIG. 1, are that: the inward projecting tabs 22a,b are trapezoidal in shape, and that the lid 12 comprises a pair of parallel slits 26. The slits 26 are positioned such that, when the lid is in a closed position, each of the slits comes into proximity with the leading, inward edge of a respective tab 22a. The trapezoidal shape of the tabs 22a,b has the effect of preventing the tabs from obstructing or interfering with each other, or with the walls of the container, when the end walls 4,4a are folded inwards to partially collapse the container. In addition, the trapezoidal shape confers a narrower portion at the leading edge of the tabs 22a,b which, in the case of the tabs 22a, facilitates their insertion into the respective slits 26 in the lid 12, thus releasably fastening the lid in a closed position. Typically tabs 22a are folded over the lid, whilst tabs 22b are folded beneath the lid.

Similarly, FIG. 3A shows a third embodiment of a flat blank suitable for assembly into a container in accordance with the invention, and comprises a sheet of polypropylene. The blank is substantially similar to the embodiment illustrated in FIG. 1, and like components are denoted by common reference numerals. The most significant difference between the two embodiments is that the blank shown in FIG. 3A does not incorporate, as an integral feature, a lid. Instead, this is provided as a separate component, as the blank shown in FIG. 3B. The lid is formed by folding, cutting and assembling from the blank of FIG. 3B, and then joined (by ultrasonic welding) to the container formed from the blank of FIG. 3A. Preferably the lid is joined to the top edge wall 14a of the secondary compartment of the assembled container. The other differences relative to the embodiment shown in FIG. 1 are as described in relation to the second embodiment (i.e. trapezoidal shaped tabs 22a,b; and pair of slits 26 in the lid).

FIGS. 4A and 4B show a fourth embodiment of a flat blank suitable for assembly in accordance with the invention. FIG. 4A shows the embodiment with secondary compartment components (14, 14a, 16), whilst the embodiment shown in FIG. 4B is essentially identical but has no secondary compartment components. The embodiments are substantially similar to that illustrated in FIG. 1, and like components are denoted by common reference numerals. The maximum dimensions of the blank, in its flat form, are 547 mm by 360 mm in FIG. 4A, and 397 mm by 360 mm in FIG. 4B.

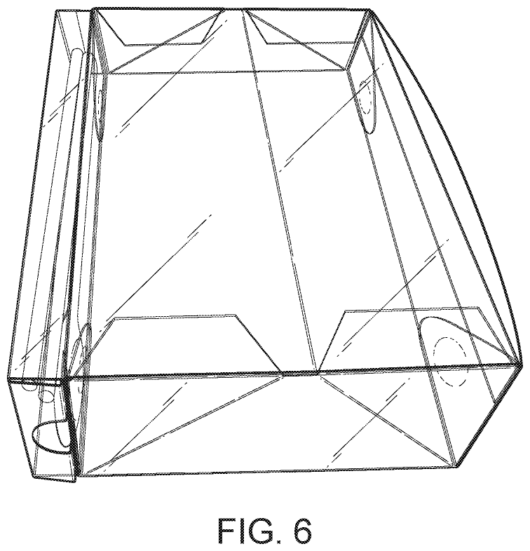

FIGS. 5 and 5b are pictures of a container, assembled from a blank similar to that illustrated in FIG. 1, in its erected configuration and with the lid 12 open. The main compartment 30 for temporary storage of food can be seen, along with the secondary compartment 32 which, in this instance, contains one or more items of cutlery. FIGS. 6-8 are pictures of the same container, from different angles, with the lid 12 closed.

1. A container for a foodstuff, the container being convertible between an at least partially collapsed configuration and an erected configuration, the container being washable and re-usable and wholly or substantially formed of a synthetic plastics material which is foldable and impermeable, wherein the container comprises a main body having a rectangular or square base surrounded by, and joined to, upright side and end walls, defining a main compartment volume for receiving a foodstuff, and a lid for covering the foodstuff within the container, and wherein, in said at least partially collapsed configuration the side and end walls are folded inwardly and the lid is folded over one of said inwardly folded side walls.

2. The container according to claim 1, wherein the lid comprises a crease or fold line, at or about a mid-line across the lid.

3. The container according to claim 1, wherein the container is wholly or substantially formed from a single piece of foldable, synthetic plastics substrate.

4. The container according to claim 1, wherein the container is erected from a flat blank.

5. The container according to claim 1, wherein the container is wholly or substantially formed from polypropylene.

6. The container according to claim 1, wherein the container is microwaveable, washable, re-usable, and, in its erected configuration, substantially leak-proof.

7. The container according to claim 1, wherein the container further comprises a secondary compartment.

8. The container according to claim 1, wherein the lid and/or the main body is provided with releasable fastening means to fasten the lid in the closed position when desired, whilst allowing the lid to be opened to permit consumption of the foodstuff.

9. The container according to claim 8, wherein the lid is releasably fastened by a press stud arrangement, or a tab/flap arrangement, in either of which there is co-operation between respective features on the lid and the main body of the container to effect the fastening.

10. The container according to claim 8, wherein the lid releasable fastening means comprises at least one tab on each of a pair of opposed end walls, which tab is inserted into a respective co-operating slit provided in the lid when the lid is in the closed position.

11. The container according to claim 1, wherein the synthetic plastics material is impregnated with or otherwise comprises an antimicrobial additive.

12. The container according to claim 1, wherein a plurality of the walls of the container each comprise at least one respective fold line or crease which facilitates inward partial collapse of the aforesaid walls.

13. The container according to claim 12, wherein at least one respective fold line or crease which facilitates inward partial collapse is provided in each of a pair of opposed end walls of the container.

14. The container according to claim 13, wherein inward partial collapse of the opposed end walls induces inward folding of the opposed side walls of the container.

15. A flat blank of foldable, synthetic plastics material, adapted and configured to be folded and assembled into a container in accordance with claim 1.

16. A method of making a container according to claim 1, from a flat blank of foldable synthetic plastics material, the method comprising the steps of: (a) cutting out or other otherwise excising from a foldable synthetic plastics substrate a suitably shaped and dimensioned blank; (b) forming fold lines, creases or score lines in the substrate material; and (c) folding the blank along the fold lines, creases or score lines and securing the blank in its assembled configuration.

17. A method according to claim 16, wherein step (c) comprises ultrasonic welding or other thermoplastic welding.

18. A method according to claim 16, further comprising the step of assembling a separate component, and joining the assembled separate component to the rest of the container.

19. A method according to claim 18, wherein the separate component is a lid or a secondary compartment for the main container.

20. A packaged foodstuff, packaged within a container in accordance with claim 1.

21-23. (canceled)
